(19) United States
(12) Patent Application Publication
(10) Pub. No.: US 2005/0101301 A1
(43) Pub. Date: May 12, 2005

(54) Apparatus and method for storing/reproducing voice in a wireless terminal

(75) Inventors: Hyun-Soo Kim, Yongin-si (KR); Jung-Seung Lee, Yongin-si (KR); Kwang-Cheol Choi, Gwacheon-si (KR); Nam-Il Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/985,868

(22) Filed: Nov. 12, 2004

(30) Foreign Application Priority Data
Nov. 12, 2003 (KR) 2003-79939

(51) Int. Cl. H04B 1/46

(52) U.S. Cl. 455/412.1; 455/414.1

(57) ABSTRACT

A system and method for recording conversation voice signals in a wireless terminal. The wireless terminal determines whether a current conversation state is a silence state or a voice state. If the current conversation state is a voice state, the wireless terminal stores packet data. If the current conversation state is a silence state, the wireless terminal stores information regarding the number of silence frames.

### CROSS-REFERENCE TO RELATED APPLICATIONS

This application claims the benefit under 35 U.S.C. § 119(a) of Korean Patent Application No. 2003-79939 entitled “Apparatus and Method for Storing/Reproducing Voice in a Wireless Terminal”, filed in the Korean Intellectual Property Office on Nov. 12, 2003, the entire contents of which are incorporated herein by reference.

### BACKGROUND OF THE INVENTION

1. Field of the Invention

The present invention relates generally to an apparatus and method for processing signals in a wireless terminal. More particularly, the present invention relates to an apparatus and method for storing/reproducing conversation voice signals in a wireless terminal.

2. Description of the Related Art

A method for storing voice signals during conversations in a conventional wireless terminal is typically divided into a method for storing only reception voice signals and a method for storing both transmission voice signals and reception voice signals using a separate external device. However, based on the fact that in most cases, only one of a called party and a calling party talks during a call, an improved method has been proposed for either measuring energy for a predetermined period (such as 20 msec) of transmission/reception voice samples and storing a voice sample period having an energy value larger than a predetermined threshold, or determining whether there is voice signal and storing a voice sample period for which there is a voice signal.

The conventional method for storing only reception voice signals is advantageous in that it is simple in implementation and has a relatively small amount of data to be stored, but this method is disadvantageous in that it cannot store transmission voice signals. When transmission voice signals and reception voice signals are separately recorded using a separate external device in order to solve such a problem, a hardware structure of the wireless terminal becomes undesirably complicated.

When compared with the conventional methods, the improved method for storing voice sample energy for a predetermined time (such as 20 msec) of transmission/reception of voice samples or storing a voice sample period by determining whether there is voice signal, is more efficient in storing transmission/reception voice signals. However, because the improved method does not also consider a silence situation which may frequently occur during a voice call, it stores unnecessary data. In addition, because the improved method stores voice samples, it cannot determine whether a corresponding voice signal is a transmission voice signal or a reception voice signal, making it impossible to selectively reproduce voice signals.

In addition, because a concurrent conversation state is not taken into consideration, a calling party's voice signal or a called party's voice signal having higher energy is selectively recorded and reproduced in a concurrent conversation period, making it difficult to continuously record/reproduce the conversation.

Accordingly, a need exists for a system and method for simultaneously recording transmission/reception voice signals without requiring a separate external device.

### SUMMARY OF THE INVENTION

It is, therefore, an object of the present invention to provide an apparatus and method for simultaneously recording transmission/reception voices (hereinafter referred to as voice signals) without a separate external device.

It is another object of the present invention to provide an apparatus and method for efficiently reproducing voice data while also considering the occurrence of a frequent silence period.

It is another object of the present invention to provide an apparatus and method for securing continuity of previous voice signals during voice reproduction in a concurrent conversation state.

It is yet another object of the present invention to provide an apparatus and method for separately reproducing transmission voice signals and reception voice signals.

In accordance with one aspect of the present invention, a method is provided for recording conversation voice signals in a wireless terminal. The method comprises the steps of determining whether a current conversation state is a silence state, and storing packet data if the current conversation state is a voice state. If the current conversation state is a silence state, then the method comprises steps for storing information regarding the number of silence frames.

In accordance with another aspect of the present invention, a method is provided for reproducing conversation voice signals in a wireless terminal that stores a current conversation state and the conversation voice signals. The method comprises the steps of determining whether a current conversation voice frame to be reproduced is a silence frame according to the stored conversation state or if the current conversation voice frame is a voice frame. If the current conversation voice frame is a voice frame, then the method comprises steps for converting stored packet data into audible sound. If the current conversation voice frame is a silence frame, then the method comprises steps for turning off a speaker.

In accordance with yet another aspect of the present invention, an apparatus is provided for recording/reproducing conversation voice signals in a wireless terminal. In the apparatus, a reception part demodulates/decodes a digital-converted received radio frequency (RF) signal into an audible signal, and then outputs the audible signal through a speaker included therein. A transmission part encodes/modulates user voice signals from a microphone included therein. A recording controller outputs a control signal indicating whether a current conversation state is a voice state or a silence state. A memory selectively stores the packet data, or stores a silence period and associated flag according to the control signal. A reproducing controller checks a flag that specifies a current conversation state of data stored in the memory, selectively decodes the encoded frame, converts the decoded frame into an audible signal that can be output through the speaker, and turns the speaker on or off, accordingly.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a wireless terminal according to an embodiment of the present invention;

FIG. 2 is a detailed block diagram for illustrating an operation of storing and reproducing voice signals in the wireless terminal illustrated in FIG. 1;

FIG. 3A is a flowchart illustrating a method for storing voice signals according to an embodiment of the present invention;

FIG. 3B is a detailed flowchart illustrating the process of determining the current voice state in FIG. 3A;

FIG. 3C is a detailed flowchart illustrating the process of storing a silence flag and information regarding the number of frames in a silence period in FIG. 3A;

FIG. 4 is a diagram illustrating an example of a stored voice data format according to an embodiment of the present invention; and

FIG. 5 is a flowchart illustrating a method for reproducing voice signals according to an embodiment of the present invention.

Throughout the drawings, like reference numerals will be understood to refer to like parts, components and structures.

### DETAILED DESCRIPTION OF THE EXEMPLARY EMBODIMENTS

An exemplary embodiment of the present invention will now be described in greater detail with reference to the annexed drawings. In the following description, a detailed description of functions and configurations incorporated herein and well known to those skilled in the art, has been omitted for conciseness.

The present invention discloses a system and method for determining whether there is a voice (hereinafter referred to as “voice signal”) at a terminal, and to further determine whether a current terminal state is a transmission state (Tx) or a reception state (Rx) depending upon voice activity (hereinafter referred to as “rate information”) determined in a voice compression/expansion device (hereinafter referred to as a “vocoder”), and to then efficiently store voice data according to the determination result. The present invention further discloses a system and method for selectively reproducing the stored voice signals according to the transmission/reception state, and the transmission voice signals or reception voice signals.

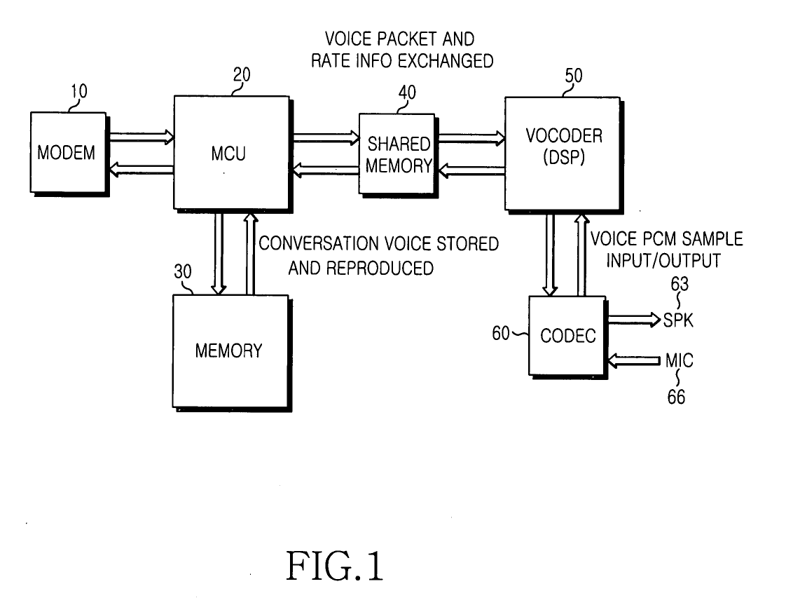

FIG. 1 is a block diagram illustrating a wireless terminal according to an embodiment of the present invention. Although not illustrated in the drawing but provided as an input signal, a radio frequency (RF) signal is received via an antenna, down-converted into an intermediate frequency (IF) signal, and then converted into a digital signal. Referring to FIG. 1, the digital signal is then input to a modem 10, and the modem 10 demodulates the digital input signal and outputs the demodulated signal to a microprocessor unit (MCU) 20. The MCU 20, if configured to support Code Division Multiple Access (CDMA) technology, then accesses coding rate information by detecting a frame format every 20 msec, and transmits the coding rate information and packet data based on the information to a vocoder 50.

In this example, the MCU 20 accesses the coding rate information every 20 msec because a voice channel frame of a CDMA forward traffic channel is transmitted every 20 msec. The data rate information is information indicating a bit rate at which packet data transmitted from a transmission side was encoded, and is then recorded in a packet register located in the vocoder 50. The vocoder 50 decodes input data packets according to the data rate information recorded in the packet register, and outputs the decoded data packets as Pulse Code Modulation (PCM) voice data samples.

The PCM voice data samples output from the vocoder 50 are input to a codec 60. The codec 60 converts the voice data samples output from the vocoder 50 into an analog voice signal. The analog voice signal is provided to a speaker (SPK) 63 where it is converted into audible sound.

An analog voice signal input from a microphone (MIC) 66 is converted into PCM voice sample data in the codec 60 located on a path of a reverse traffic channel, and is then encoded at an appropriate data rate in the vocoder 50 before being transmitted. The path of the reverse traffic channel is opposite to the path of the forward traffic channel in operation.

In a CDMA mobile communication system, a transmission side encodes voice signals using a vocoder, and converts the encoded voice signals into a frame format having multiple coding rates according to the amount of information. For example, a 13 K QCELP (Qualcomm Code Excited Linear Prediction) vocoder selects one of a full rate, ½ rate, ¼ rate and ⅛ rate as a coding rate of a voice signal, and an 8 K EVRC (Enhanced Variable Rate Coder) vocoder selects one of a full rate, ½ rate, ¼ rate and ⅛ rate as a coding rate of a voice signal before transmission. Such coding rate information is stored in a format byte of a packet, and is comprised of 2 bits. The frame format of voice data always has a length of 20 msec regardless of the variable coding rate. The vocoder selects a coding rate according to the amount of voice information.

Upon receiving data over a forward traffic channel, a CDMA terminal detects a format byte in one frame of a voice channel to detect a coding rate. Such a CDMA terminal then decodes encoded voice data according to the coding rate information included in the detected format byte. Encoding and decoding of voice data is performed by a vocoder in the CDMA terminal, and the vocoder decodes data packet information in received frame data into voice signals through a PCM codec according to a QCELP algorithm. The voice data decoded by the vocoder is reproduced into an analog voice signal by the PCM codec, and then output to the speaker SPK. A memory 30 stores various data including voice data, and can be a flash memory capable of storing data even in a power-off state.

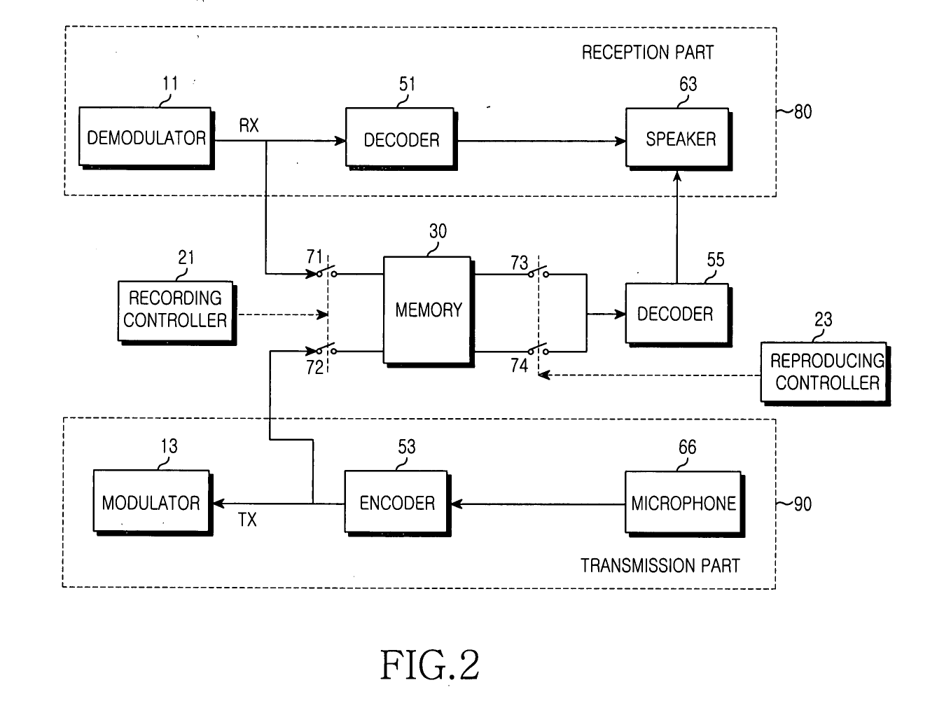

FIG. 2 is a detailed block diagram for illustrating an operation of storing and reproducing voice signals in the wireless terminal illustrated in FIG. 1. Referring to FIG. 2, as described in conjunction with FIG. 1, a reception voice signal is demodulated by a demodulator 11 of the modem 10, and the demodulated voice signal is decoded by a decoder 51 of the vocoder 50, and then output to the speaker 63. A transmission voice signal input from the microphone 66 is encoded by an encoder 53 of the vocoder 50, and the encoded voice signal is modulated by a modulator 13 of the modem 10.

A recording controller 21 in the MCU 20 determines whether a corresponding voice signal is a transmission voice signal or a reception voice signal, and controls switches 71 and 72 according to the determination result when storing voice packets output from the demodulator 11 of the modem 10 and the encoder 53 of the vocoder 50 in the memory 30. A reproducing controller 23 in the MCU 20 controls switches 73 and 74 such that packet data stored in the memory 30 is separately reproduced into transmission voice signals and reception voice signals, or simultaneously reproduced.

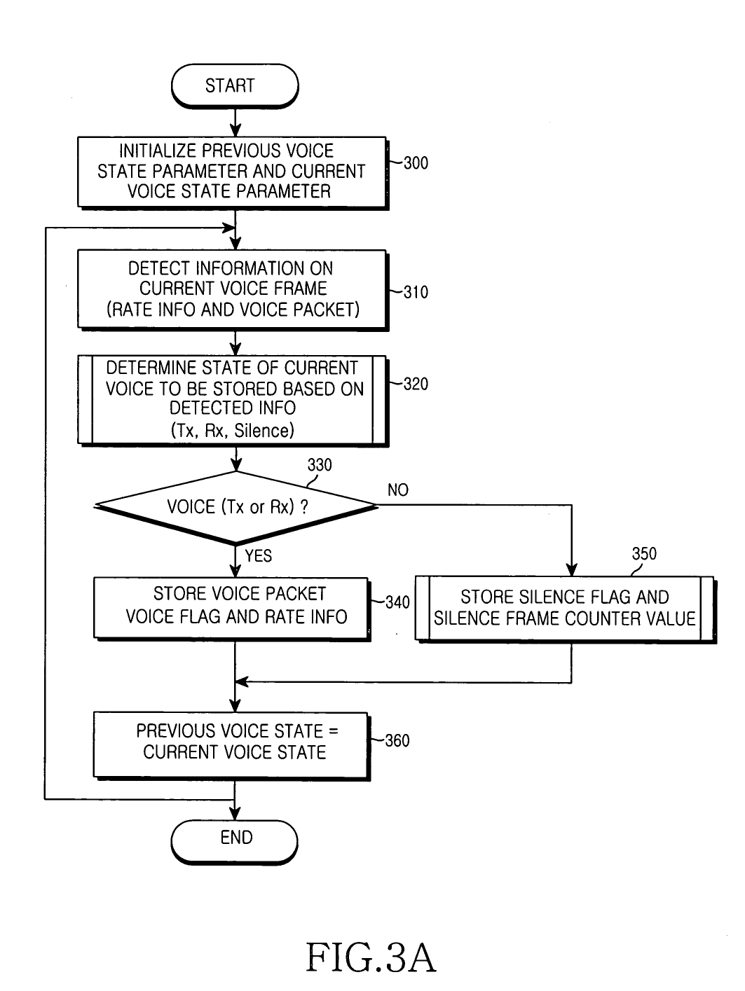

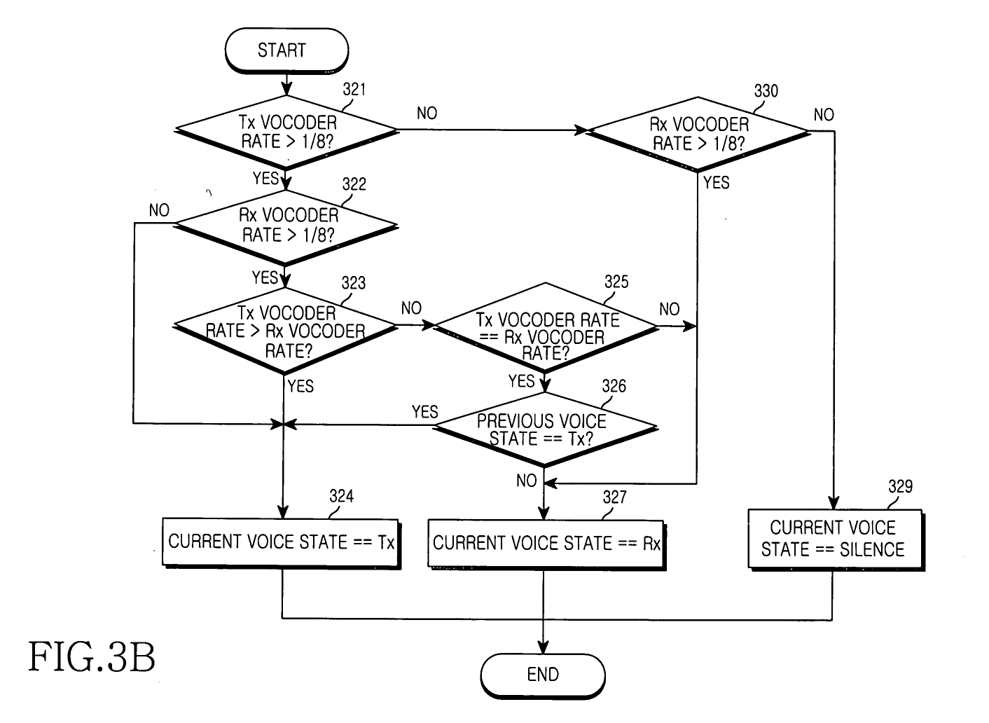

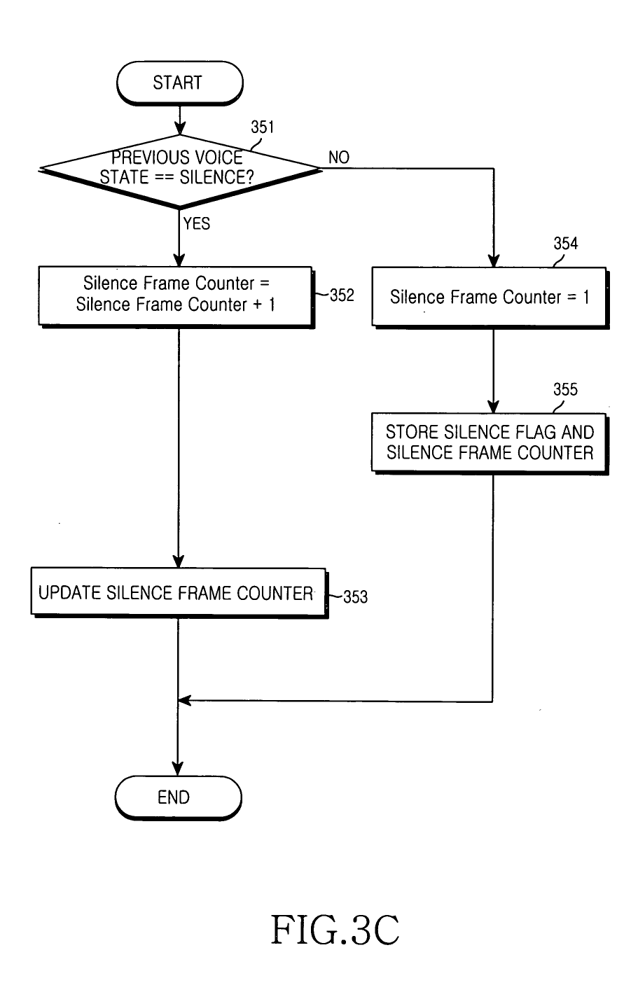

A detailed operation of the MCU 20 will now be described in greater detail herein below with reference to FIGS. 3A to 5. FIG. 3A is a flowchart illustrating a method for storing voice signals according to an embodiment of the present invention. The voice storing method of FIG. 3A is controlled by the recording controller 21 illustrated in FIG. 2.

Referring to FIG. 3A, in step 300, the recording controller 21 initializes a previous voice state parameter and a current voice state parameter. In step 310, the recording controller 21 detects information regarding a rate for a current voice frame (20 msec) and voice packet, and determines in step 320 whether the current voice signal to be stored, based on the detected information, is a transmission voice (Tx), reception voice (Rx), or no-voice (Silence).

In step 330, the recording controller 21 determines whether the current voice state indicates silence. If it is determined in step 330 that the current voice state does not indicate silence, the recording controller 21 stores packet data and also stores a voice flag and rate information in step 340. However, if it is determined in step 330 that the current voice state indicates silence, the recording controller 21 stores a silence flag and information regarding the number of frames in a successive silence period in step 350. Thereafter, in step 360, the recording controller 21 sets the previous voice state to the current voice state, and then returns to step 310.

A basic data storing process collects rate information of transmission/reception data and packet data processed in the current frame, determines whether a called party currently talks or a calling party currently talks according to the rate information of transmission/reception voice signals, and stores voice data of the party who is currently talking according to the determination result.

In this case, two exceptional situations can happen. A first case can occur where both the calling party and the called party are not talking, and a second case can occur where both the calling party and the called party are talking.

In the first case, because there is no transmission/reception voice signal, it is not necessary to store data. In this state, the wireless terminal is allowed to store only the information indicating that the current frame has no voice signals as described above. Also, as the first case will happen over several 20-msec frames, the wireless terminal is allowed to store only the information regarding the number of frames if there is no voice frame. If rate information indicates a full rate, ½ rate and ¼ rate, there is high probability that corresponding data is voice signals, such that the wireless terminal should preferably perform voice processing. However, if rate information indicates a ⅛ rate, the wireless terminal regards a corresponding period as a silence period.

In the second case corresponding to a concurrent conversation state and taking the continuity of voice signals stored in a previous frame into consideration, the wireless terminal stores transmission data if the previous frame is a transmission frame, and stores reception data if the previous frame is a reception frame.

FIG. 3B is a detailed flowchart illustrating the process of step 320 for determining the current voice state in FIG. 3A. Referring to FIG. 3B, in step 321, the recording controller 21 determines whether a transmission vocoder rate is higher than a ⅛ rate. If it is determined in step 321 that the transmission vocoder rate is higher than a ⅛ rate, the recording controller 21 determines in step 322 whether a reception vocoder rate is higher than a ⅛ rate. If it is determined in step 322 that the reception vocoder rate is higher than a ⅛ rate, the recording controller 21 compares the transmission vocoder rate with the reception vocoder rate in step 323. If it is determined in step 323 that the transmission vocoder rate is higher than the reception vocoder rate, the recording controller 21 then sets the current voice state to the transmission state in step 324. However, if it is determined in step 323 that the transmission vocoder rate is not higher than the reception vocoder rate, the recording controller 21 determines in step 325 whether the transmission vocoder rate is equal to the reception vocoder rate. If it is determined in step 325 that the transmission vocoder rate is equal to the reception vocoder rate, the recording controller 21 determines in step 326 whether a previous voice state is a transmission state. If it is determined in step 326 that the previous voice state is a transmission state, the recording controller 21 then sets the current voice state to the transmission state in step 324. However, if it is determined in step 326 that the previous voice state is not a transmission state, the recording controller 21 sets the current state to a reception state in step 327.

However, if it is determined in step 321 that the transmission vocoder rate is not higher than a ⅛ rate, the recording controller 21 determines in step 330 whether the reception vocoder rate is higher than a ⅛ rate. If it is determined in step 330 that the reception vocoder rate is higher than a ⅛ rate, the recording controller 21 sets the current voice state to the reception state in step 327. However, if it is determined in step 330 that the reception vocoder rate is not higher than a ⅛ rate, the recording controller 21 sets the current voice state to a silence state in step 329.

FIG. 3C is a detailed flowchart illustrating the process of step 350 for storing a silence flag and information regarding the number of frames in a silence period in FIG. 3A. Referring to FIG. 3C, in step 351, the recording controller 21 determines whether a previous voice state is a silence state. If it is determined in step 351 that the previous voice state is a silence state, the recording controller 21 increases a silence frame counter value by 1 in step 352, and then updates a silence frame counter with the increased silence frame counter value in step 353. However, if it is determined in step 351 that the previous voice state is not a silence state, the recording controller 21 initializes the silence frame counter to ‘1’ in step 354, and then stores the initialized silence frame counter value and a silence flag in step 355.

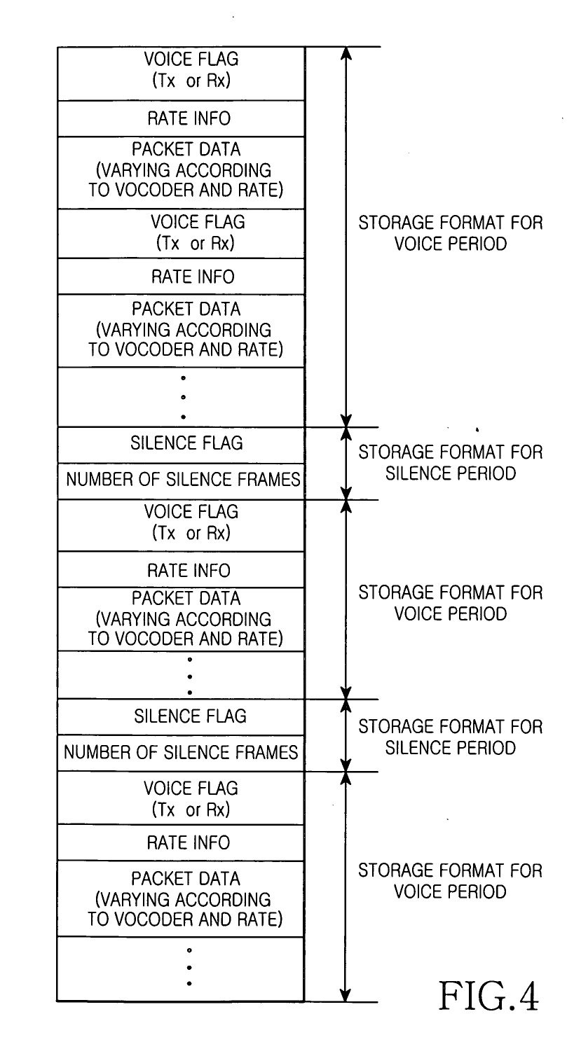

FIG. 4 is a diagram illustrating an example of a stored voice data format according to an embodiment of the present invention. Referring to FIG. 4, in a voice period, a voice flag indicating whether a corresponding voice signal is a transmission voice signal or a reception voice signal, rate information, and packet data based on the rate, are each stored in sequential order. By storing the voice flag which is capable of distinguishing transmission voice signals from reception voice signals in this way, it is possible to selectively reproduce transmission voice signals, reception voice signals, or transmission/reception voice signals according to a user's choice. In a silence period, a silence flag and information regarding the number of successive frames are stored. Because a wireless terminal does not store unnecessary data in the silence period, the wireless terminal can more efficiently use and manage it's memory.

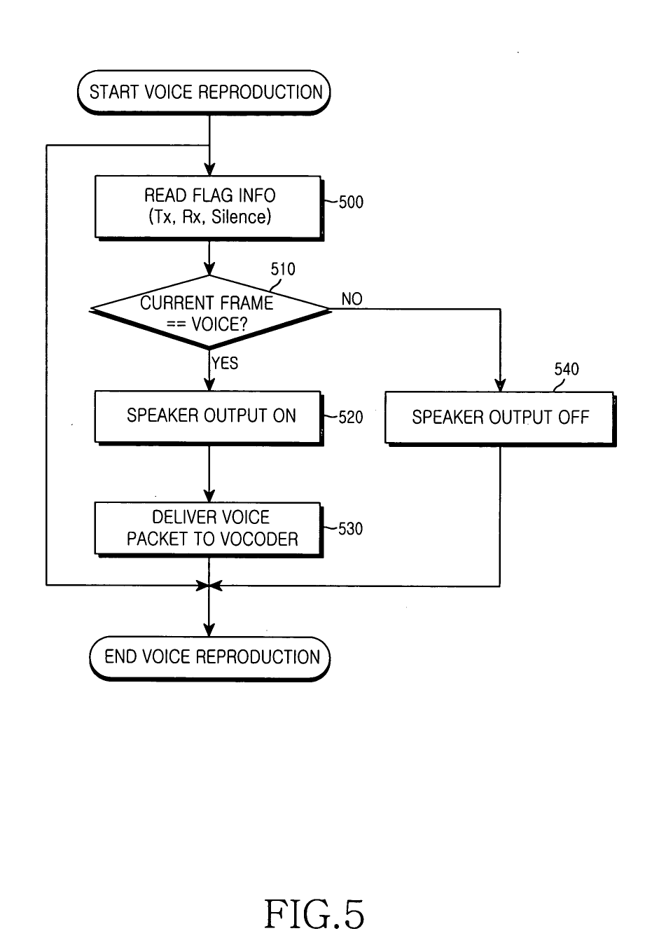

FIG. 5 is a flowchart illustrating a method for reproducing voice signals stored in the format illustrated in FIG. 4. Referring to FIG. 5, in step 500, the reproducing controller 23 of the wireless terminal reads flag information of data stored in the memory 30, and determines in step 510 whether a current frame is a voice frame. If it is determined in step 510 that the current frame is a voice frame, the reproducing controller 23 proceeds to steps 520 and 530, where it delivers stored packet data to a decoder 55 of the vocoder 50, and the decoder 55 decodes the packet data and outputs the decoded voice data to the speaker 63. However, if it is determined in step 5 10 that the current frame is a silence frame, the reproducing controller 23 turns off the speaker 63 in step 540 for a time corresponding to the number of successive silence frames, thereby reproducing voice signals while maintaining continuity of voice reproduction.

As can be understood from the foregoing description, the wireless terminal according to embodiments of the present invention can simultaneously record transmission/reception voice signals without a separate external device, and more efficiently store voice data by detecting frequent silence periods. In addition, in a concurrent conversation state, the wireless terminal continuously reproduces voice signals thereby increasing the accuracy of voice reproduction, and can simultaneously or separately reproduce transmission and reception voice signals.

While the invention has been shown and described with reference to certain exemplary embodiments thereof, it will be understood by those skilled in the art that various changes in form and details may be made therein without departing from the spirit and scope of the invention as defined by the appended claims.

1. A method for recording conversation voice signals in a wireless terminal, comprising the steps of:
determining whether a current conversation state is a silence state;
storing packet data if the current conversation state is determined to be a voice state; and
storing information regarding the number of silence frames if the current conversation state is determined to be a silence state.

2. The method of claim 1, wherein the step of determining whether a current conversation state is a silence state comprises the step of:
determining whether the current conversation state is a voice state or a silence state according to whether a vocoder rate for a current transmission frame or a reception frame is higher than a predetermined value.

3. The method of claim 2, wherein the step of determining whether a current conversation state is a silence state further comprises the steps of:
detecting a frame having a higher vocoder rate from among vocoder rates of the transmission frame and the reception frame if states of the current transmission frame and the reception frame are both a voice state; and
determining whether a current voice state is a transmission voice state or a reception voice state.

4. The method of claim 3, wherein the step of determining whether a current conversation state is a silence state further comprises the step of:
setting the current voice state to a previous voice state if a vocoder rate of the transmission frame is equal to a vocoder rate of the reception frame.

5. The method of claim 3, wherein the step of determining whether a current conversation state is a silence state further comprises the step of:
setting the current voice state to a transmission voice state if a vocoder rate of the transmission frame is equal to a vocoder rate of the reception frame and the previous voice state is a transmission voice state.

6. The method of claim 3, wherein the step of determining whether a current conversation state is a silence state further comprises the step of:
setting the current voice state to a reception voice state if a vocoder rate of the transmission frame is equal to a vocoder rate of the reception frame and the previous voice state is a reception voice state.

7. The method of claim 1, wherein the step of storing information regarding the number of silence frames comprises the step of initializing the number of silence frames if the previous voice state is not a silence state.

8. The method of claim 1, wherein the step of storing information regarding the number of silence frames comprises the step of increasing the number of silence frames if the previous voice state is a silence state.

9. A method for reproducing conversation voice signals in a wireless terminal that stores a current conversation state and the conversation voice signals, the method comprising the steps of:
determining whether a current conversation voice frame to be reproduced is a silence frame according to the stored conversation state;
converting stored packet data into audible sound if the current conversation voice frame is a voice frame; and
turning off a speaker if the current conversation voice frame is a silence frame.

10. The method of claim 9, wherein the step of turning off a speaker comprises the steps of:
detecting a number of silence frames; and
turning off the speaker for a time corresponding to the number of silence frames detected.

11. An apparatus for recording/reproducing conversation voice signals in a wireless terminal, comprising:
a reception part for demodulating or decoding a digital-converted received radio frequency (RF) signal into an audible signal and outputting the audible signal through a speaker included therein;
a transmission part for encoding or modulating user voice signals from a microphone included therein;
a recording controller for outputting a control signal indicating whether a current conversation state is a voice state or a silence state;
a memory for selectively storing at least one of a packet data, a silence period, and a flag according to the control signal; and
a reproducing controller for checking a flag that specifies a current conversation state of data stored in the memory, selectively decoding the encoded frame, converting the decoded frame into an audible signal that can be output through the speaker, and selectively turning the speaker off and on.

12. The apparatus of claim 11, wherein the recording controller further comprises:
a detection member to detect a frame format from a demodulated encoded signal output from the reception part and an encoded signal output from the transmission part;
an access member to access coding rate information of the transmission and reception frames; and an output member to output a control signal indicating whether the current conversation state is a voice state or a silence state.
